(19) United States
(12) Patent Application Publication
(10) Pub. No.: US 2003/0105671 A1
(43) Pub. Date: Jun. 5, 2003

(54) CLIENT CARD MAIL SYSTEM

(75) Inventor: HEIZO KITAJIMA, KOGA-SHI (JP)

Correspondence Address: SMITH, GAMBRELL & RUSSELL, LLP, 1850 M STREET, N.W., SUITE 800, WASHINGTON, DC, 20036, US

(73) Assignee: Michael A. Makuch

(21) Appl. No.: 09/391,459

(22) Filed: Sep. 8, 1999

(30) Foreign Application Priority Data
Feb. 24, 1999 (JP) 47059/1999

(51) Int. Cl. G06F 17/60

(52) U.S. Cl. 705/26

(57) ABSTRACT

A client card mail system, comprising: means for storing client information including individual information of clients' code number, name, sex distinction, age, address and telephone number; means for storing information of the goods for sales company for the sales goods, departments, classes of the goods name, goods codes, prime unit prices, and sales unit prices; means for storing information of the goods purchased by the clients; and means for retrieving clients' information of the clients who actually purchased the goods setting the conditions of periods and goods classes from the information of the goods purchased; and means for outputting and printing the results retrieved. According to the present invention, the clients' taste and living custom can be grasped to enable propaganda activity without waste, and there is provided a client card mail system making use of a method for storage and retrieval of fractionalized data.

### BACKGROUND OF THE INVENTION

The present invention relates to a client card mail system making use of a method for storage and retrieval of fractionalized data, by which clients' taste and living custom are grasped so as to enable propaganda activity.

In the conventional client card mail system, cards are issued on the basis of individual information such as addresses, telephone numbers and so on of clients, and when clients purchase the goods or receive services so that delivery and reception of money between sellers and clients occur, points according to an amount of money are added to present services, present the novel goods or mail an addressed advertisement(DM).

However, for example, in the case where a selling agent which sells various goods sells the goods called D of the goods C handled by a department B of a company A, there is a client who takes either the goods C of a company E or the goods C of a company F depending on the client. Further, for example, depending on separate clients, there is a client who purchases only the goods called D of the goods C handled by a department B of a company A, and there is a client who does not purchase the sales goods of the department B.

As described above, there is a problem in that even if the selling agent advertises enclosing circulars of a special sale for the goods in which clients are not interested to clients having different demands, tastes, desires and the like, such an advertisement mailed is quite useless because the client who received the notice will not buy unnecessary goods.

### SUMMARY OF THE INVENTION

It is therefore an object of the present invention to provide a client card mail system having a method for storage and retrieval of fractionalized data incorporated therein, by which clients' taste and living custom are grasped from the sales goods purchased by the clients previously so as to enable useful propaganda activity of the goods.

According to the present invention, there is provided a client card mail system, comprising: means for storing client information in which individual information of clients' code number, name, sex distinction, age, address and telephone number; means for storing information of the goods for sales company for the sales goods, departments, classes of the goods name, goods codes, prime unit prices, and sales unit prices; means for storing information of the goods purchased by the clients; and means for retrieving clients' information of the clients who actually purchased the goods setting the conditions of periods and goods classes from the information of the goods purchased; and means for outputting and printing the results retrieved, so as to enable useful propaganda activity of the sales goods.

### BRIEF DESCRIPTION OF THE DRAWINGS

FIG. 1 is a view showing main parts of a client card mail system according to the present invention;

FIG. 2 is a flow chart for storing the good purchase data of clients using a main computer 1 and a terminal of the client card mail system according to the present invention;

FIG. 3 is an illustrative view of individual information of clients stored in the client card mail system according to the present invention;

FIG. 4 is an illustrative view of purchased data of clients stored in the client card mail system according to the present invention;

FIG. 5 is a flow chart showing data take-in and data retrieval in the client card mail system according to the present invention;

FIG. 6 is a view illustrating the result of retrieval of the goods to which the retrieving conditions are set in the client card mail system according to the present invention;

FIG. 7 is a display on the screen of the main computer 1 when the client card mail system according to the present invention is carried out, showing a client card mail system menu screen;

FIG. 8 is a display on the screen of the main computer 1 when the client card mail system according to the present invention is carried out, showing a sales data take-in screen;

FIG. 9 is a display on the screen of the main computer 1 when the client card mail system according to the present invention is carried out, showing a client information output menu screen;

FIG. 10 is a display on the screen of the main computer 1 when the client card mail system according to the present invention is carried out, showing a client retrieval screen;

FIG. 11 is a table when the client card mail system according to the present invention is carried out to output the result of retrieval;

FIG. 12 shows an example wherein the client card mail system according to the present invention is carried out to output the result of retrieval to an addressed seal;

FIG. 13 is a display on the screen of the main computer 1 when the client card mail system according to the present invention is carried out, showing an unworking client retrieval screen;

FIG. 14 is a table when the client card mail system according to the present invention is carried out to output the result of retrieval;

FIG. 15 is a display on the screen of the main computer 1 when the client card mail system according to the present invention is carried out, showing a master maintenance selection screen;

FIG. 16 is a display on the screen of the main computer 1 when the client card mail system according to the present invention is carried out, showing a district master maintenance selection screen;

FIG. 17 is a display on the screen of the main computer 1 when the client card mail system according to the present invention is carried out, showing a goods master maintenance screen; and

FIG. 18 is a display on the screen of the main computer 1 when the client card mail system according to the present invention is carried out, showing a client master maintenance screen.

### DESCRIPTION OF THE PREFERRED EMBODIMENTS

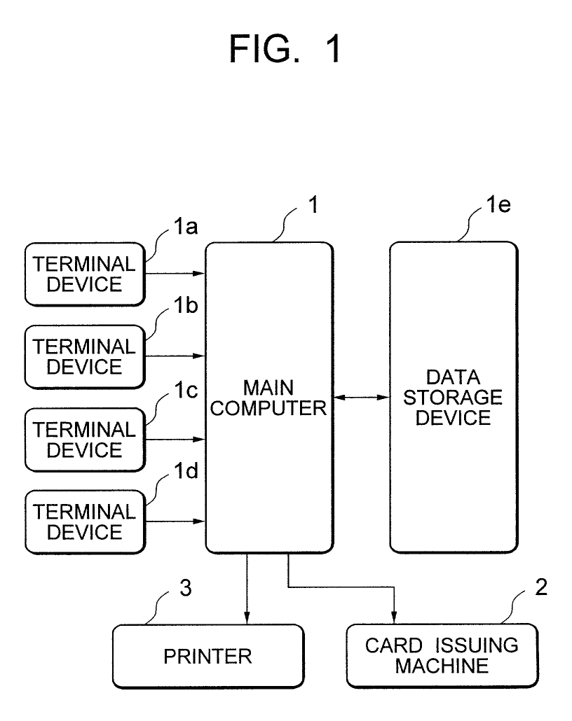

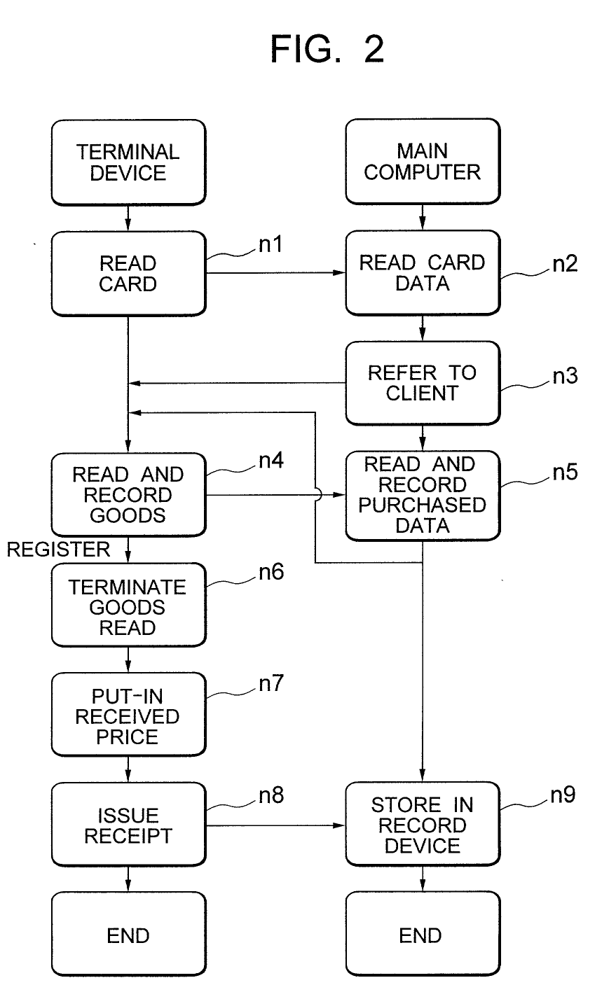

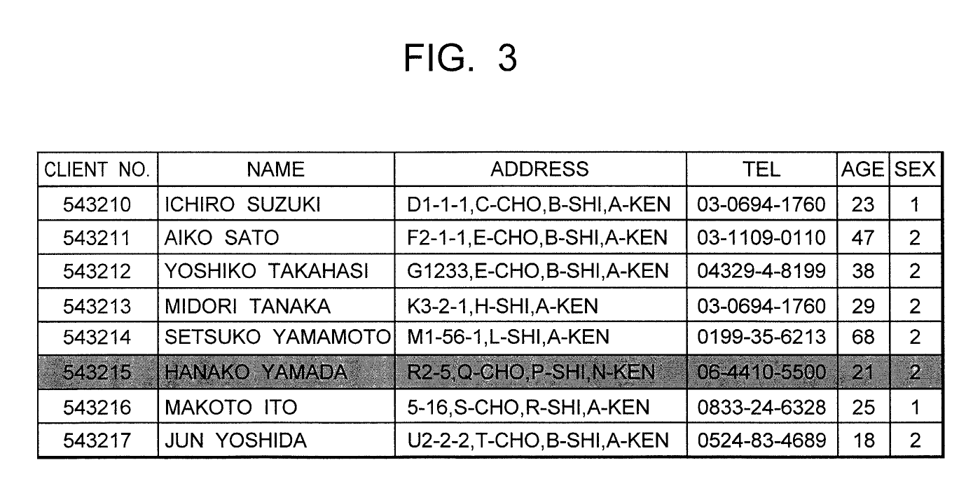

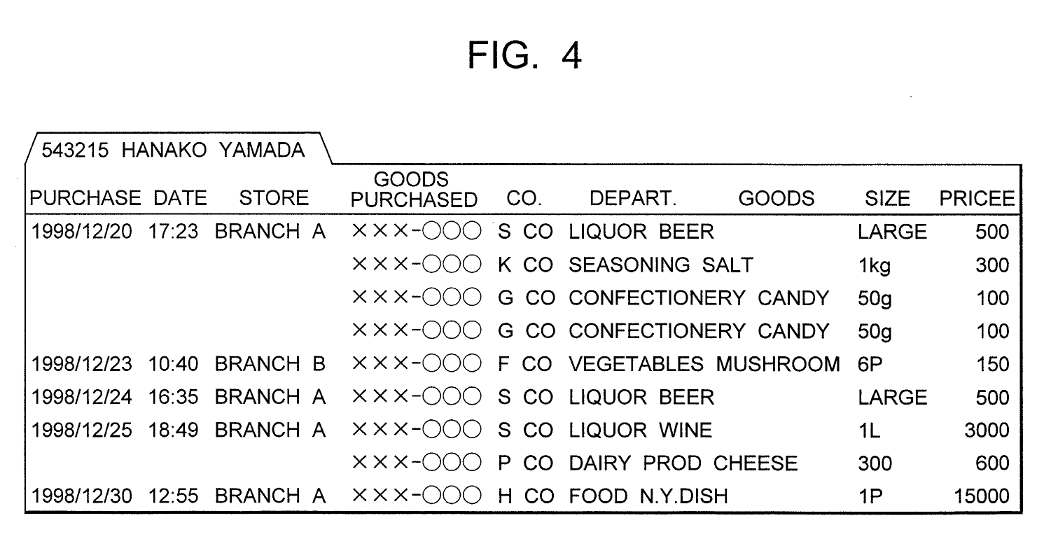

The client card mail system according to the present invention will now be described in detail with reference to the accompanying drawings. FIG. 1 is a view showing main parts of a client card mail system according to the present invention; FIG. 2 is a flow chart for storing the good purchase data of clients using a main computer 1 and a terminal of the client card mail system according to the present invention; FIG. 3 is an illustrative view of individual information of clients stored in the client card mail system according to the present invention; and FIG. 4 is an illustrative view of purchased data of clients stored in the client card mail system according to the present invention.

The client card mail system according to the present invention is carried out making use of a computer comprising an input apparatus for client information provided with a main computer 1 and terminal devices 1a, 1b, 1c and 1d and a data storing apparatus 1e, and a card issuing machine 2 are combined, and a client card issuing system, as shown in FIG. 1. As the client management apparatus and the client card issuing system, a conventional device, for example, a POS device may be used.

As shown in FIG. 1, the terminal devices 1a, 1b,1c and 1d are a terminal machine having a scanner or the like and connected to a store processor or the like to perform a unit article information management, which is called a so-called POS terminal or merely POS (Point On Sales) (sales point information management).

In the client management and the client card issuing system, information is registered in the terminal devices 1a, 1b, 1c and 1d at the store front on the basis of a registration sheet entered (filled up) by the client who desires an information registration for having a service of the store, or a sheet is sent to a card issuing central issuing agent or the like where information is registered in the main computer 1 by an operator or the like, or each client registers the client's own information in the terminal devices 1a, 1b, 1c and 1d att the store front or other terminals.

Concurrently with the registration, a number for client management is given to each client, and as shown in FIG. 3, data are stored in a registered member file along with client's individual information. Then, a number of each client, the registered individual information and the like are stored in a read and write memory medium, and the card is sent to each client for issuance.

Each client carries the card, and as shown in FIG. 2, when paying money for the goods purchased or the service presented, a salesman (saleswoman) or a client himself uses the card to read the card data in the terminal devices 1a, 1b, 1c and 1d (n1) and connect to a network (n2). Collation is made with individual information stored in the main computer 1 on the basis of individual information recorded in the card (n3), and reference of client is made to the terminal devices 1a, 1b, 1c and 1d.

In the terminal devices 1a, 1b, 1c and 1d, the price for the purchased goods is entered in a register, or a bar code is read by a laser scanner or the like so that data of the purchased goods or data of the presented service are repeatedly read every goods in the main computer 1 (n4, n5, n6). The salesman receives the money (n7) and issues a receipt (n8). Concurrently with the issuance of the receipt, purchase information of a client is stored in a data storing device 1e (n9).

When the purchase information of a client is confirmed on the screen of the client card mail apparatus, as shown in FIGS. 3 and 4, clients are lined up in order of numbers given as shown in FIG., 3 on the computer screen, and for example, when one out of the client information is selected, the goods purchased data of the client selected is displayed as shown in FIG. 4, which is readily distinguished.

According to the present invention, as shown in FIG. 3, circulars or addressed advertisements are mailed, to many clients with clients' goods purchase data gathered in the main computer 1 applied with special conditions, or being telephoned for propaganda advertisement to promote the purchase of the goods.

The data take-in and the data retrieval will be described in detail hereinafter.

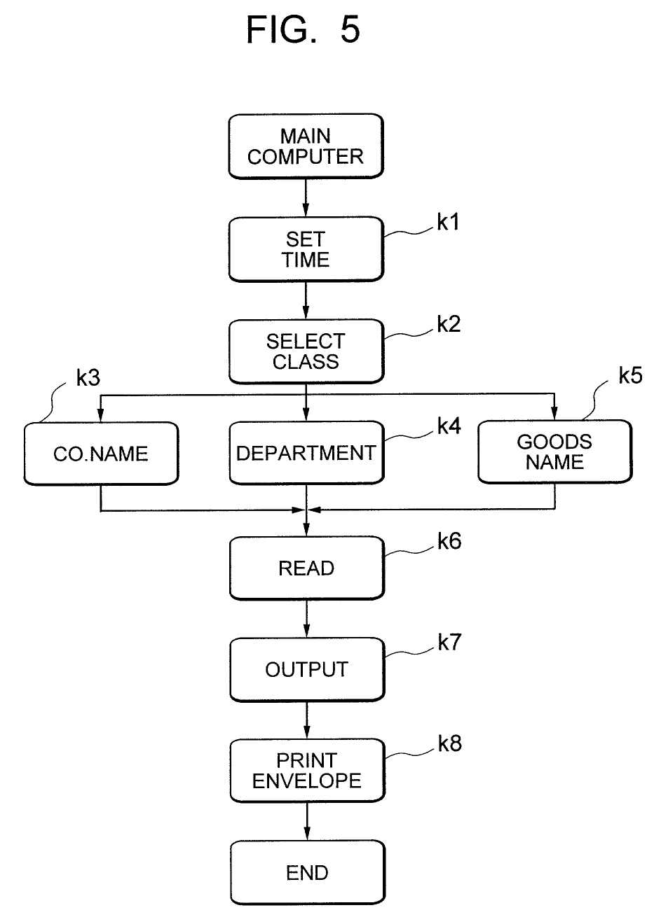

FIG. 5 is a flow chart showing data take-in and data retrieval in the client card mail system according to the present invention. In the client card mail system according to the present invention, the retrieval by classes can be made. For example, referring to FIG. 4, in the case where circulars for special sales of the goods, beer xxx-ooo of liquor sold by company S, are sent to specific clients, the circulars may be sent to only the clients who have purchased the goods previously on the basis of sales information.

Further, in the case where circulars for specific sales of the entire beer are desired to be sent, the circulars for specific sales of beer are not sent to clients who take no beer or clients who take no liquor but the circular for specific sales may be sent to only the clients who have purchased beer actually previously.

So, in the client card mail system according to the present invention, the retrieval can be made with respect to the goods for which propaganda advertisement is carried out in company for the goods, departments, the goods, and classes of the goods names.

Initially, as shown in FIG. 5, in the main computer 1, purchase time for the goods advertised is set (k1). Preferably the aforesaid time is suitably set according to the goods advertised and the sales time, for example, such as from January to February, a spring season (from Marcy to May), since opening a store, or for one year last year. By setting the time as described, it is possible to omit clients who have not visited the store and have not purchased anything recently.

Next, whether or not retrieval is made by the company, or by the department, or by the goods is selected in class (k2). In the present selection, clients who desire the specific goods or clients who desire the goods of specific companies are selected, an clients who have purchased the goods advertised are extracted.

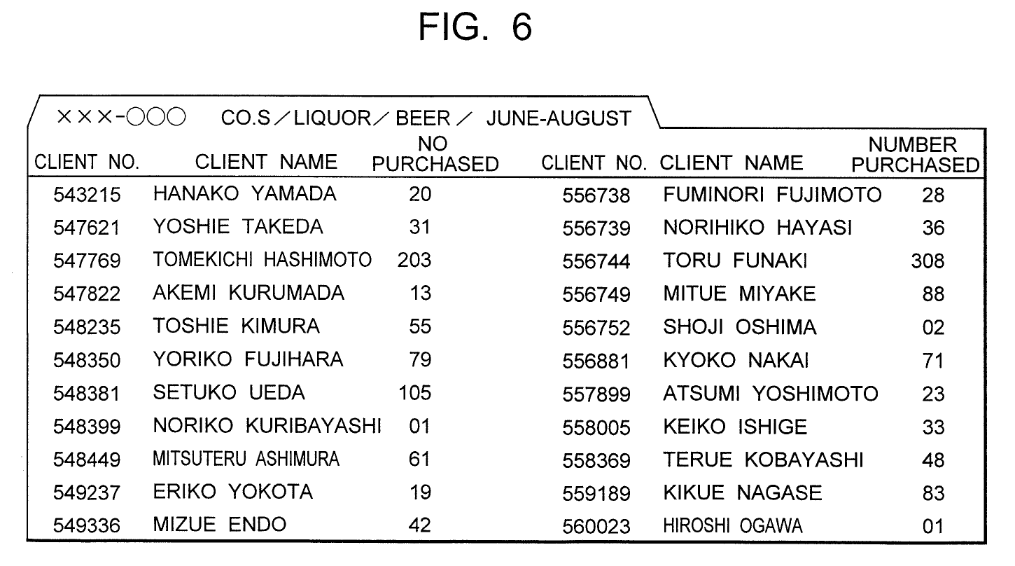

Next, the retrieval is carried out in the selected class (k3, k4, k5), which is displayed on the screen, for example. FIG. 6 illustrates the state in which when the goods are selected in class and the retrieval is made, the result of retrieval is read (k6), which is displayed on the screen of the main computer 1.

FIG. 6 is a view illustrating the result of retrieval of the goods to which the retrieving conditions are set in the client card mail system according to the present invention. This displays the result of retrieval relative to “Sales goods referred to the goods name xxx-ooo” with “time setting is a summer season (from June to August)”, and “class selection is the goods”. It is effective that when clients are selected on the screen, sales information of the clients can be readily observed., As shown in FIG. 5, the retrieval result which was read and displayed on the screen is output (k7). The address and the postal code are printed on an envelope using a printer 3 shown in FIG. 1 on the basis of the retrieval result output (k8).

An apparatus may be employed in which an envelope is printed by the printer 3 and at the same time the circulars are sealed into an envelope. Alternatively, an envelope is not printed but an address and a dwelling place are printed on an addressed seal, circulars are sealed into an envelope, a seal is pasted, and an addressed advertisement is prepared.

Further, circulars with a plurality of the goods combined, for example, circulars on which articles for special sale of different kinds such as beer, sliced raw fish, a kind of Chinese cabbage, and gum are prepared. Simultaneously, when clients' names and addresses applied to the goods advertized are printed on envelopes and the circulars are sealed thereinto on the basis of the retrieval result of clients for advertisement of the plurality of the goods, more effective propaganda activity can be performed.

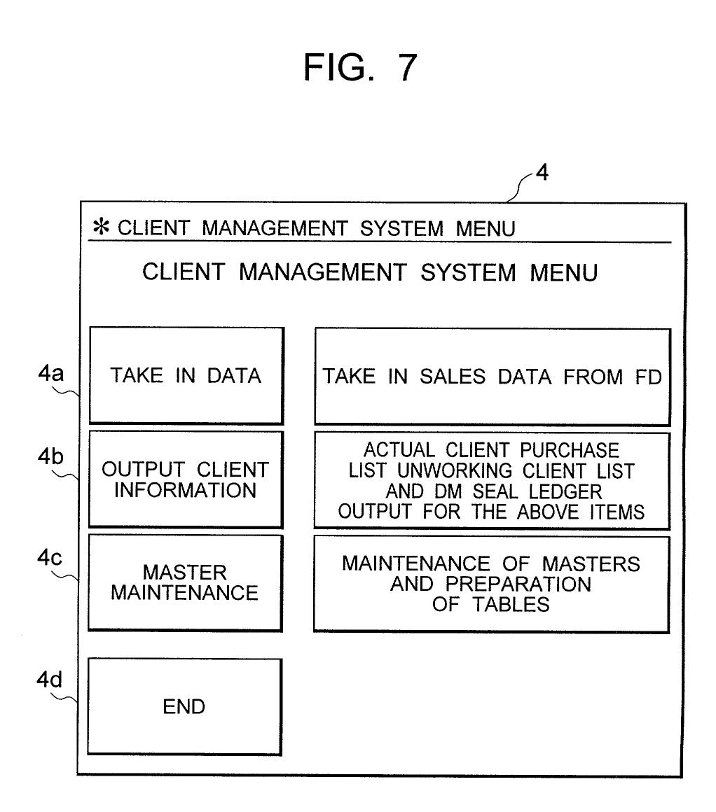

FIGS. 7 to 15 show the screen displays when a program for the client card mail system according to the present invention is prepared and carried out on the main computer 1 actually. The present embodiment is not carried out by taking-in sales data from the terminal devices 1a, 1b, 1c and 1d shown in FIG. 1, so-called POS terminals on the on-line but carried out by the main computer 1 in which the sales data gathered in the main computer 1 are once shifted to a magnetic memory medium, a so-called floppy disk (hereinafter called FD) or the like to actuate the present system. Of course, the program executed in the present client card mail system may be incorporated in the main computer 1 shown in FIG. 1.

FIG. 7 is a display on the screen of the main computer 1 when the client card mail system according to the present invention is carried out, showing a client card mail system menu screen. The client card mail system according to the present invention is provided with three modes of embodiments, i.e., “Sales data are taken in from a recording medium”, “Client information is retrieved and drawn out, clients' retrieval information are shown in a table, and an addressed advertisement is prepared”, and “Master data is input”.

As shown in FIG. 7, “Client card mail system menu”, which is a client card mail system menu screen 4, is provided with a sales data take-in button 4a, a client information output button 4b, a master maintenance button 4c, and a termination button 4d.

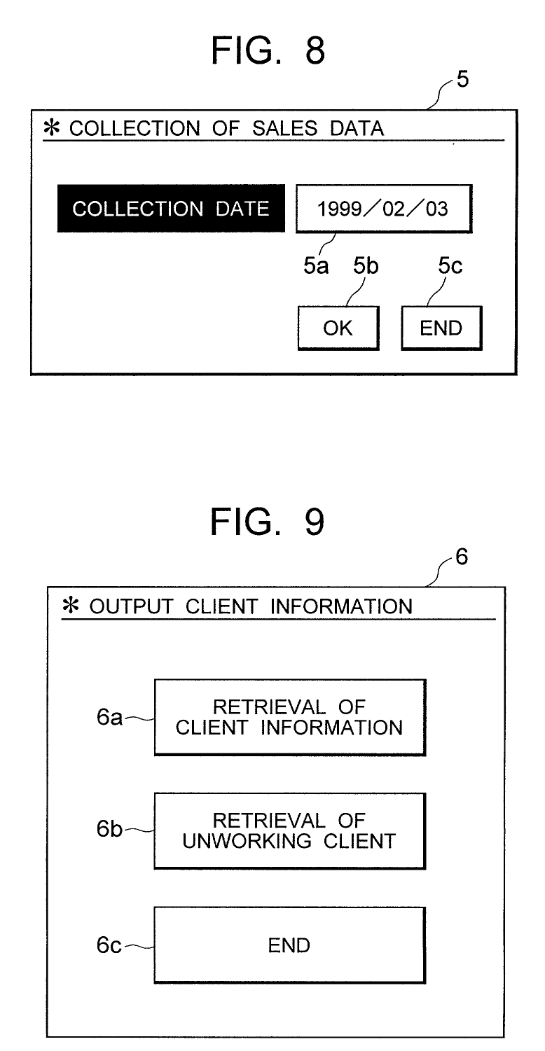

Here, when the sales data take-in 4a is selected, sales information or the like can be taken into the present client card mail system from FD or the like to apply a date. Alternatively, not reading from FD, but a program stored in the main computer 1 is incorporated into a main computer 1′ which controls the terminal devices 1a to 1d, and terminal information (POS terminal information) is instantaneously taken in on the on-line. The sales data take-in 4a will be described with reference to FIG. 8.

When the client information output 4b is selected, client information can be extracted and drawn out on the basis of the retrieval conditions set from data stored in the main computer 1, and the name and address for addressed advertisement can be printed on an addressed seal on the basis of the selected client information. The client information output 4b will be described with reference to FIGS. 9 to 14.

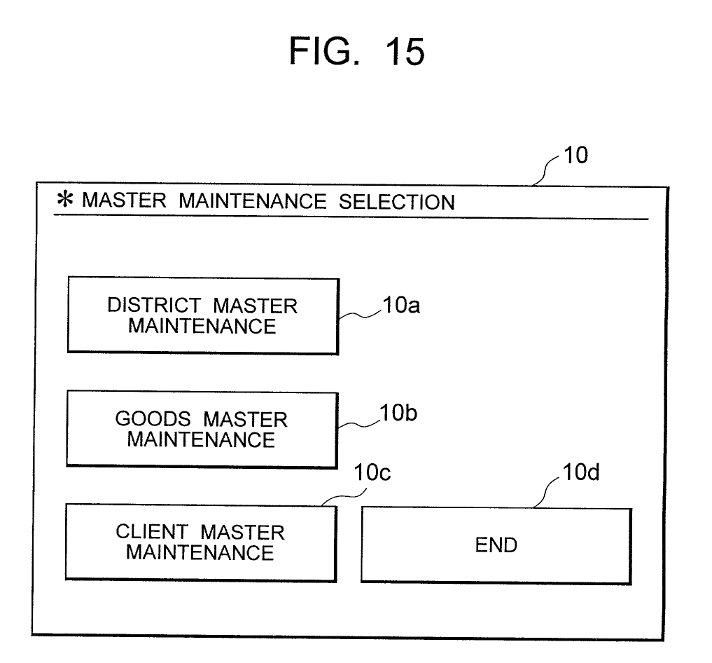

When the master maintenance 4c is selected, it is possible to perform inputting, changing and deleting of data which rarely change through a certain period, a so-called master record. In the present client card mail system, regional information, goods information and client information correspond to the master record. Data of the present master record are stored in a file in which all the information necessary for data processing are collected, a so-called basic file (called a master file also). The master maintenance 4c will be described with reference to FIGS. 15 to 18.

When the termination 4d is selected, the client card mail system menu screen 4 is closed to terminate the program for the client card mail system.

In the following, three modes of embodiments, i.e., the sales data take-in 4a, the client information output 4b, and the master maintenance 4c will be described in order with reference to the display screen.

FIG. 8 is a display on the screen of the main computer 1 when the client card mail system according to the present invention is carried out, showing a sales data take-in screen. In the present embodiment, there is employed a program in which sales data are collected every day and taken into the main computer 1. Therefore, when sales data are taken into the main computer 1 by FD, data are stored after the take-in date has been applied to data.

This is because records such as when sales data were taken in, and when was the latest input (that is, the latest update date of sales data) are left.

When sales data are taken into the main computer 1 from FD, they may be taken in without applying dates relative to all the data. When the sales data take-in button 4a, in which dates and time on which clients purchase the goods are shown in FIG. 7, is depressed, the sales data collection screen 5 appears.

The sales data collection screen 5 is provided, as shown in FIG. 8, with a date write-in column 5a, a OK button 5b, and a termination button 5c. A FD is inserted into a read/write device, a so-called floppy disk drive provided in the main computer 1, a date of sales data stored in the FD is written into the date write-in column 5a, and when the OK button 5b is depressed, data is taken into the main computer 1. The termination button 5c is depressed to close the sales data collection screen 5, then returning to the client card mail system menu which is the client card mail system menu screen 4.

FIG. 9 is a display on the screen of the main computer 1 when the client card mail system according to the present invention is carried out, showing a client information output menu screen. In the present embodiment, the conditions comprising a master record of regional information, goods information and client information and sales data can be set to extract and draw out the client information in which the specific goods are purchased.

A name and an address for mailing an addressed advertisement to the client can be printed on the basis of the client information extracted. When the client information output button 4b shown in FIG. 7 is depressed, the client information output menu screen 6 shown in FIG. 9 appears.

The present client information output screen 6 is provided with a client information retrieval button 6a, an uncorking client retrieval button 6b, and a termination button 6c.

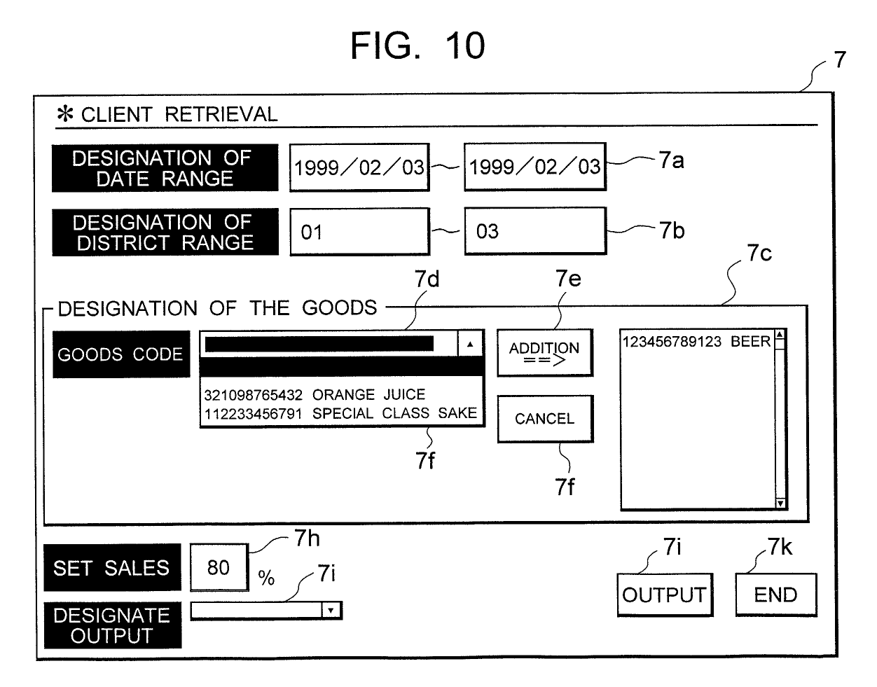

When the client information retrieval 6a is selected, the conditions for retrieving the client information can be set, and the client information can be collated with the conditions and extracted. The client information retrieval 6a will be described with reference to FIG. 10.

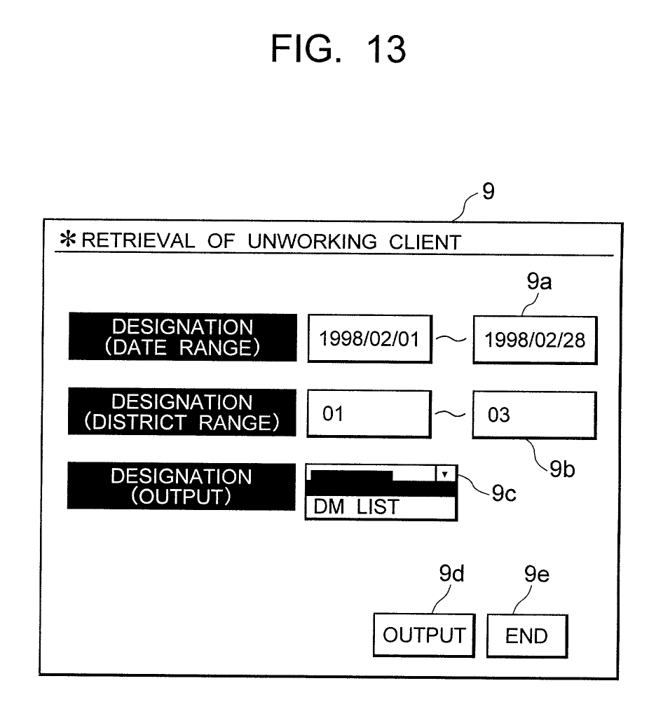

Here, when the uncorking client retrieval 6b is selected, it is possible to extract and output clients who has no actual purchase result of the goods advertised within a set period of time, and output mailing of an addressed advertisement on the basis of the retrieval result. The uncorking client retrieval 6b will be described with reference to FIG. 13.

When the termination button 6c is depressed, the client information output screen 6 is closed, then returning to the client card mail system menu screen 4. Two embodiment modes, i.e., the client information retrieval 6a and the uncorking client retrieval 6b will be described in order with reference to the display screen.

FIG. 10 is a display on the screen of the main computer 1 when the client card mail system according to the present invention is carried out, showing a client retrieval screen. When the client information retrieval button 6a shown in FIG. 9 is depressed, the client retrieval screen 7 shown in FIG. 10 appears.

The present client retrieval screen 7 is provided with a date range designation column 7a, a region range designation column 7b, a goods designation 7c, a sales rate setting column 7h, an output designation column 7i, an output button 7j, and a termination button 7k. In the present client retrieval screen 7, the conditions of a time range, a regional range, and the goods are imposed to retrieve and select clients to which circulars of the goods are distributed.

In the date range designation column 7a, the time for retrieving the client who purchased the goods designated in a certain time is set. The region range designation column 7b is the column which for example, in a branch store for special sale, sets the retrieval conditions for specifying the goods purchaser class who lives in a certain regional range about the branch store.

The goods designation 7c sets the goods put on circulars out of a plurality of the goods. That is, this is the column (item) for setting the designated goods in order to retrieve the goods purchaser who purchases the goods in a certain time and lives in the designated region for distributing circulars for advertisement of the designated goods.

The goods designation 7c is provided with a goods code selection column 7d, an addition 7e, a cancellation 7f, and a goods code setting column 7g. The goods is selected from the goods code selection column 7d, and the addition button 7e is depressed to take it into the goods code setting column 7g. When the goods taken in is mistaken, the cancellation button 7f is depressed to make the goods code setting column 7g empty.

The sales rate setting column 7 is provided to set a plurality of actual purchases because when all the members who have experience to purchase the goods are extracted, clients who accidentally stop over at the store to buy the goods are also extracted.

It is understood from the Repert principle that a few number of clients indicates the major part of sales of the goods. Therefore, for example, where the sales rate is set to 80%, out of clients having the actual purchases of the goods designated in the goods designation 7c, high-ranking clients who contribute to sales of 80% of the entirety from the total sales of the goods are extracted.

The output designation column 7i designates a method for outputting the result of retrieval carried on the client retrieval screen 7, which selects and designates either client sales actual list or DM list.

When the output button 7j is depressed, the retrieval results can be tabled, or the retrieval results can be printed on an addressed seal. When the termination button 7k is depressed, the client retrieval screen 7 is closed, then returning to the client information output menu screen 6.

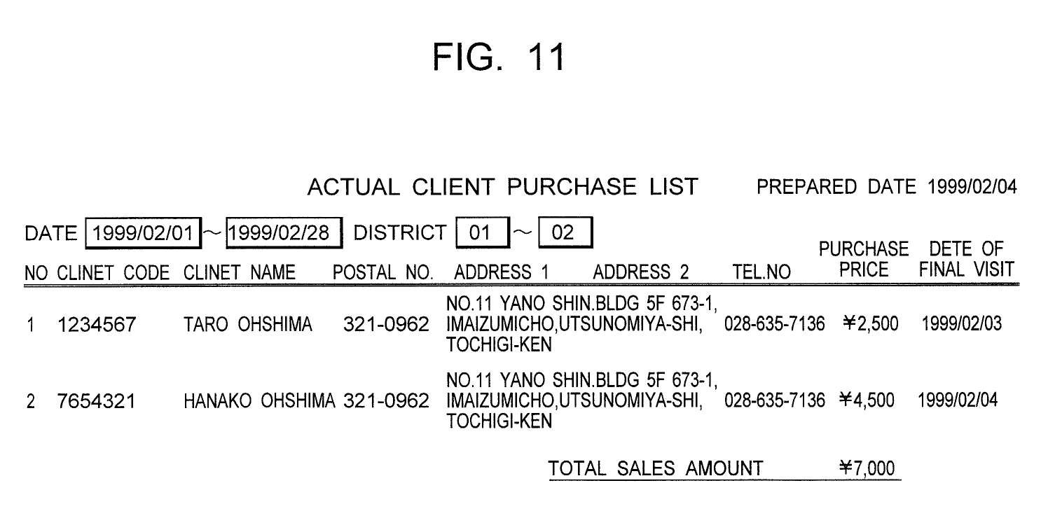

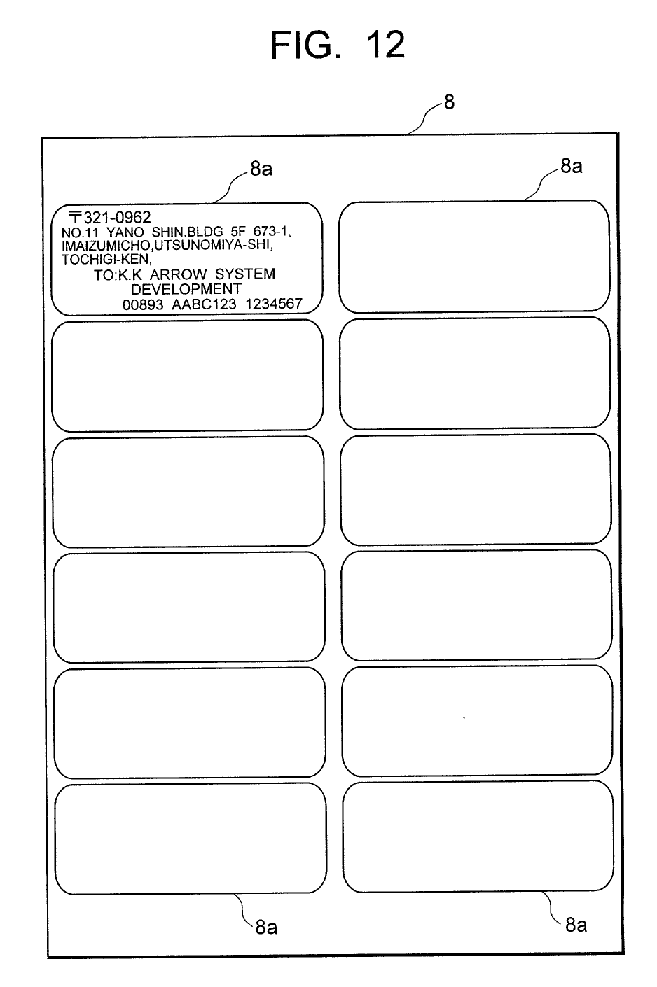

FIG. 11 is a table when the client card mail system according to the present invention is carried out to output the result of retrieval; and FIG. 12 is a client actual sales list showing an example wherein the client card mail system according to the present invention is carried out to output the result of retrieval to an addressed seal.

FIG. 11 shows an output example when the output designation 7i is selected on the client actual sales list in the client retrieval screen 7 shown in FIG. 10. Individual information such as a client code, a name, a postal number, an address, a telephone number of the client, the purchase price within a designated period of the designated good and the final date of visit, out of information of clients who have experience to buy the goods obtained as a result of retrieval, are output to the client actual sales list in the form of a table in order, and the total of the goods purchase prices obtained by the retrieval is also displayed.

FIG. 12 shows an output example when the output designation 7i is selected on the DM list in the client retrieval screen 7 shown in FIG. 10. Individual information of the postal number, address and name for mailing an addressed advertisement with circulars for the designated goods enclosed to the designated goods purchasers obtained as a result of retrieval are printed on addressed seals 8a, 8a, 8a, 8a, 8a, . . . provided on a mount 8. The addressed seal 8a printed is stripped from the mount 8, and pasted at a given position of the envelope in which the circulars are sealed.

FIG. 13 is a display on the screen of the main computer 1 when the client card mail system according to the present invention is carried out, showing an unworking client retrieval screen. When the uncorking client retrieval 6b is selected in the client information output menu screen 6 shown in FIG. 9, the uncorking client retrieval screen 9 shown in FIG. 11 appears. The uncorking client retrieval screen 9 is provided with a date range designation column 9a, a region range setting column 9b, an output designation column 9c, an output button 9d, and a termination button 9e.

The uncorking client retrieval screen 9 is to extract clients who have never purchased even one goods out of clients within a designated term and a designated regional range. The screen extracts clients who have utilized the store before and have actual purchases but have not utilized the store recently, extracts clients who have not purchased the goods for a bargain sale and a special sale, or extracts clients who have not purchased the goods since a separate store is newly opened in an adjacent region.

The date range designation column 9a is to set a term for retrieving clients who have not purchased the goods in a certain term. The region range designation column 9b is the column (item), for example, in a certain branch store for a special sale, for setting the retrieval conditions for specifying the goods unpurchasers who live in the regional range about the branch store.

The output designation column 9c is to designate the method for outputting the present retrieval result carried out on the client retrieval screen 9, and select and designate either uncorking client list or DM list.

When the output button 9d is depressed, the retrieval results obtained by extracting clients who have no actual goods purchase can be tabled or the retrieval results can be printed on the addressed seal. When the termination button 9e is depressed, the uncorking client retrieval screen 9 is closed, then returning to the client information output menu screen 6.

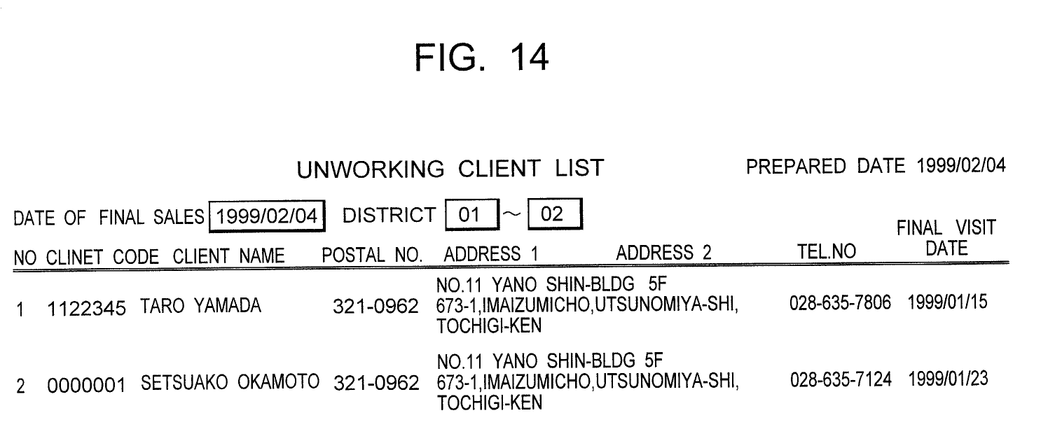

FIG. 14 is an output table when the client card mail system according to the present invention is carried out to output the result of retrieval, and is an output example when the output designation 9c is selected in the uncorking client list in the uncorking client retrieval screen 9 shown in FIG. 13. Out of client information who have no experience to buy the goods in a certain term obtained as a result of retrieval, individual information such as a client code, a name, a postal number, an address, a telephone number and a final visit date of the clients are output in a table in order to the uncorking client list.

FIG. 15 is a display on the screen of the main computer 1 when the client card mail system according to the present invention is carried out, showing a master maintenance selection screen. In the present embodiment, data which rarely change through a certain term, that is, a so-called master record of regional information, goods information and client information can be input, changed and deleted.

A master maintenance selection screen 10 is provided with a district master maintenance button 10a, a goods master maintenance button 10b, a client master maintenance button 10c, and a termination button 10d.

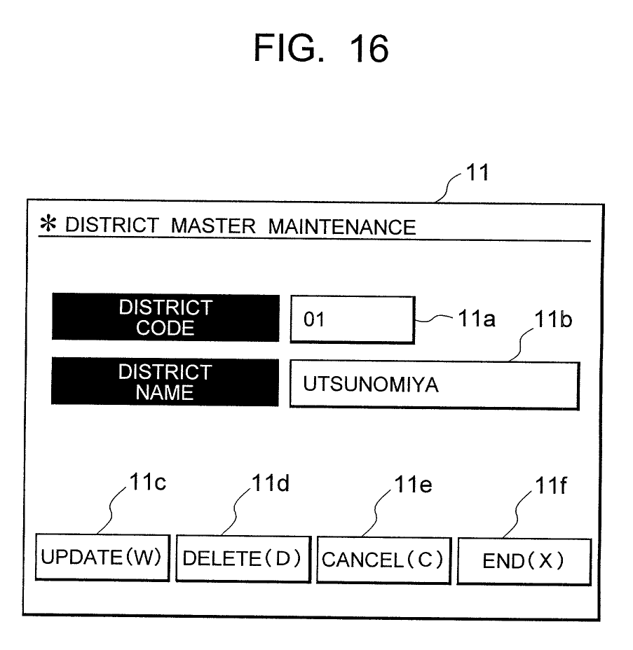

When the region master maintenance 10a is selected, a district code number that has been secured in the region or district previously in the main computer can be set and input. The district master maintenance 10a will be described with reference to FIG. 16.

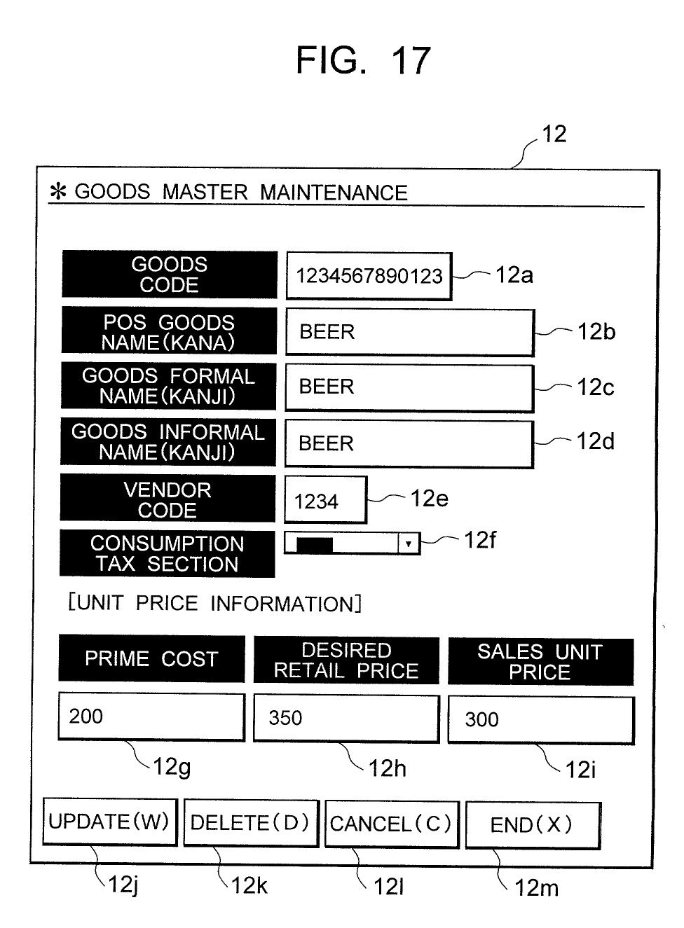

When the good master maintenance 10b is selected, the goods name, vendor, unit price and the like of the goods can be input into the main computer 1. The goods master maintenance 10b will be described with reference to FIG. 17.

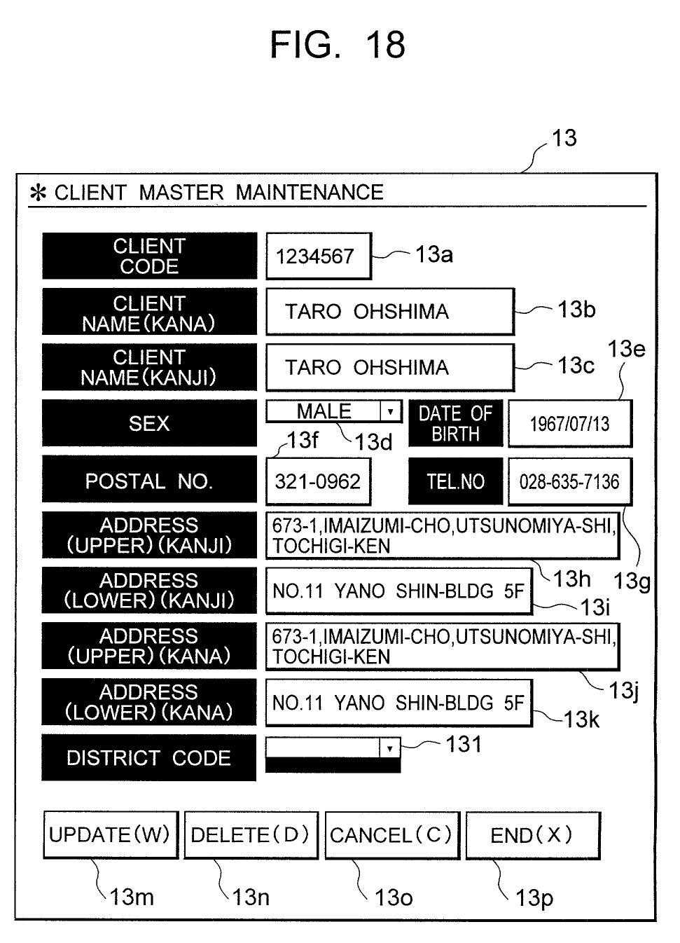

When the client master maintenance 10c is selected, the name, address, telephone number and client code of clients can be set to the main computer 1. The client master maintenance 10 will be described with reference to FIG. 18.

When the termination button 10d is depressed, the master maintenance selection screen 1 is closed, returning to the client card mail system menu screen 4.

FIG. 16 is a display on the screen of the main computer 1 when the client card mail system according to the present invention is carried out, showing a district master maintenance selection screen. A district master maintenance screen 11 is provided with a district code column 11a, a district name column 11b, an updating button 11c, a deletion button 11d, a cancellation button 11e, and a termination button 11f.

Numbers employed in the district code column 11a are entered and district names corresponding to the numbers employed in the district name column 11b are entered and registered. For example, umbers are secured every region where the branch store is present, and numbers are secured in unit of cities, towns and villages.

When the updating button 11c is depressed, the numbers described in the district codes and the names described in the district names are updated. When the deletion button 11d is depressed, the numbers described in the district code column 11a and the district names described in the district name column 11b are deleted. When the cancellation button 11e is depressed, the numbers described in the district code column 11a and the district names described in the district name column 11b are canceled to make the column empty. When the termination button 11f is depressed, the master maintenance selection screen 10 appears.

FIG. 17 is a display on the screen of the main computer 1 when the client card mail system according to the present invention is carried out, showing a goods master maintenance screen. In the present goods master maintenance screen 12, data peculiar to the goods are input into the main computer 1.

The goods master maintenance screen 12 is provided with a goods code column 12a, a POS good name column 12b, a goods formal name column 12c, a goods informal name column 12d, a vendor code column 12e, a consumption tax section 12f, a prim cost column 12g, a desired retail price column 12h, a sales unit price 12i, an updating button 12j, a deletion button 12k, a cancellation button 12l, and a termination button 12m.

The good numbers are entered in the goods code column 12a. With respect to the goods numbers, bar code numbers that are used in the world so as to be readily read by a register or a terminal device may be input. The goods names used in the POS terminal are input in katakana into the POS goods column 12b. This can be also used when being described in a receipt issued to clients who purchased the goods.

The goods names are correctly described in the goods formal name column 12c. Shortened goods names, goods names with a capital letter removed, and common names are described in the goods informal name column 12d. This can be also used when being described in a receipt issued to clients who purchased the goods.

In the vendor code column 12e, numbers are secured previously for the vendor so that the vendor can be discriminated by the number secured. The consumption tax section 12f sums up, with respect to the goods input into the main computer 1 in the goods master maintenance screen 12, the prices of the goods in the register or sets the sections of consumption tax necessary when described in the receipt.

For example, when set as an outer tax, there is displayed ¥105(Yen) obtained by adding 5% to the goods of ¥100. In case of an inner tax, the goods of ¥100 is displayed as ¥100. When summed up by the main computer 1, the price of the consumption tax can be divided and summed up while corresponding to the inner tax and outer tax of the goods.

Further, the prime price 12g related to the vendor registered in the main computer 1 on the goods master maintenance screen 12, the desire retail price 12h, and the sales unit prices 12i as the sales price can be registered.

When the updating button 12j is depressed, the goods code stored in the master code, the vendor code, the consumption tax section, the prime price, the desired retail price, and the sales unit price are updated to the number described in the goods card column 12a, the goods names described in the goods name columns 12b, 12c and 12d, the vendor number of the vendor code column 12e, the consumption tax section, the prime unit price of the unit price information column, the desired retail price and the sales unit price.

When the deletion button 12k is depressed, the number descried in the goods code registered in the master code, the goods name described in the goods name, the vendor, the consumption tax section, the prime price, the desired retail price, and the sales price are deleted.

When the cancellation button 12l is depressed, the number described in the goods code column 12a, the goods names described in the goods name columns 12b,12c, and 12d, the vendor code described in the vendor cod column 12e, the consumption tax section of the consumption tax section 12, the prime price of the prime price column 12g, the desired retail price of the desired retail price column 12h, and the sales unit price of the sales unit price column 12i are canceled to make the column empty.

When the termination button 12m is depressed, the master maintenance selection screen 10 appears.

FIG. 18 is a display on the screen of the main computer 1 when the client card mail system according to the present invention is carried out, showing a client master maintenance screen. Client individual information is registered in the main computer 1, and the client master maintenance screen 13 inputs data peculiar to the client into the main computer 1.

The client master maintenance screen 13 is provided with a client code column 13a, a client name column 13b, a client appellation column 13c, a sex distinction setting column 13d, a date of one's birth column 13e, a postal number column 13f, a telephone number column 13g, kanji input address columns 13h and 13i, katakana input address columns 13j and 13k, a district code column 13l, an updating button 11m, a deletion button 11n, a cancellation button 11o, and a termination button 11p.

A client number secured enters in the client code column 13a. The client number can be also used for a service point or the like, for example, when the goods are purchased in the register or the terminal device. A member card is issued. Client information is read by a scanner or the like before being handled by the register, a point is added to the client simultaneously with the reading of the goods, and when reaching the amount as defined, some service can be received.

Clients' names are input in katakana or alphabet into the client name column 13b, and clients' name are input in kanji into the client appellation column 13c. Katakana were used because the names are readily arranged in order of a, i, u, e and o when data are put in order. Input into the sex distinction setting column 13d, the date of one's birth column 13e, the postal number column 13f, and the telephone number column 13g are a sex distinction of a client to be registered, the date of birth of a client to be registered, a postal number of an address where a client to be registered lives, and a telephone number own by a client to be registered, respectively.

Addresses of clients are correctly described in the address columns 13h, 13i, 13j, and 13k. Katakana (or alphabet) input address columns 13j and 13k are provided because they are readily arranged in order of a, i, u, e and o (or alphabet) when data are put in order.

The district code column 13l selects and registers districts secured in number by the district master maintenance screen 11 shown in FIG. 16. The district code corresponding to the client's address is selected from the district code column 13l.

When the updating button 13m is depressed, the client information registered in the master code are updated to the number and the client name 13b described in the client code column 13a; and the client name, the sex distinction, the date of birth, the postal number, the telephone number, the address, and the district code described in the client appellation column 13c.

When the deletion button 13n is depressed, the name, address, sex distinction, date of birth, postal number and telephone number of the clients described i the client code, and the district code out of client information being registered in the master code are deleted.

When the cancellation button 13o is depressed, the number described in the client code column 13a, the clients' names described in the client name columns 13b and 13c, the sex distinction of the sex distinction column 13d, the date of birth in the date of birth column 13e, the postal number in the postal number column 13d, the telephone number in the telephone number column 13e, the addresses described in the address columns 13h, 13i, 13j and 13k, and the district code in the district code 131 are canceled to make the columns empty.

When the termination button 13p is depressed, the master maintenance selection screen 10 appears.

Further, the client card mail system according to the present invention can be also utilized by developing it on the shopping mall on the Internet.

The present invention is constituted as described above. Therefore, first, since an advertisement for cheap goods can be mailed immediately to the clients who have once purchased the goods, clients can be induced positively.

Second, since 20% of the entire client occupy 80% of total sales, clients can be retrieved to distribute an advertisement to only the clients who have actually purchased the goods, rather than distribution of circulars to the whole clients, to thereby lower the advertisement fee positively.

Third, as the effect extended from the above-described effect, there are clients scalled a bargain hunter who wonders from place to place aiming at only a bargain sale, but this is not a distribution method for an advertisement as in a newspaper advertisement which can be seen by anybody, thus preventing the purchase of the goods by clients like the bargain sale.

Fourth, since an advertisement is mailed directly, clients can be established.

What is claimed is:

1. A client card mail system, comprising: means for storing client information including individual information of clients' code number, name, sex distinction, age, address and telephone number; means for storing information of the goods for sales company for the sales goods, departments, classes of the goods name, goods codes, prime unit prices, and sales unit prices; means for storing information of the goods purchased by the clients; and means for retrieving clients' information of the clients who actually purchased the goods setting the conditions of periods and goods classes from the information of the goods purchased; and means for outputting and printing the results retrieved, thereby to enable useful propaganda activity of the sales goods.

2. The client card mail system according to claim 1, wherein said means for storing client information, said means for storing goods information and said means for storing goods sales information comprise a recording medium such as a magnetic card, a plurality of terminal devices, a main computer, and a data storing device.

3. The client card mail system according to claim 1, wherein said means for retrieving client information comprises a plurality of terminal devices and a main computer.

4. The client card mail system according to claim 1, wherein said means for outputting and printing the retrieved result comprises a printer and a card issuing machine.

5. A client card mail system comprising the steps of:
setting a purchase time of the goods advertised to a main computer, selecting a class whether retrieval is made by a company, a department or the good and carrying out the retrieval in the selected class;
reading and displaying a retrieval result on the screen;
outputting the retrieval result read and displayed on the screen; and
performing printing.
